(19) United States
(12) Patent Application Publication
(10) Pub. No.: US 2019/0354836 A1
(43) Pub. Date: Nov. 21, 2019

(54) DYNAMIC DISCOVERY OF DEPENDENCIES AMONG TIME SERIES DATA USING NEURAL NETWORKS

(71) Applicant: International Business Machines Corporation, Armonk, NY (US)

(72) Inventors: Syed Yousaf Shah, Yorktown Heights, NY (US); Xuan-Hong Dang, Chappaqua, NY (US); Petros Zerfos, New York, NY (US)

(21) Appl. No.: 15/982,615

(22) Filed: May 17, 2018

(51) Int. Cl. G06N 3/04

(52) U.S. Cl. CPC G06N 3/0445; G06N 3/0454

(57) ABSTRACT

Techniques for determining temporal dependencies and inter-time series dependencies in multi-variate time series data are provided. For example, embodiments described herein can comprise a system, which can comprise a memory that can store computer executable components. The system can also comprise a processor that can execute the computer executable components stored in the memory. The computer executable components can include: a computing component that encodes recurrent neural networks (RNNs) with time series data and determines decoded RNNs based on temporal context vectors, to determine temporal dependencies in time series data; a combining component that combines the decoded RNNs and determines an inter-time series dependence context vector and an RNN dependence decoder; and an analysis component that determines inter-time series dependencies in the time series data and forecast values for the time series data based on the inter-time series dependence context vector and the RNN dependence decoder.

### BACKGROUND

One or more embodiments relate to neural networks, and more specifically, to dynamic discovery of dependencies among multivariate time series data with deep neural networks using artificial intelligence technology.

### SUMMARY

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can autonomously determine relationships in multivariate time series data using neural networks-based artificial intelligence technology are described.

According to an embodiment, a system is provided. The system can include a memory that stores computer executable components. The system can also include a processor, operably coupled to the memory, and that can execute the computer executable components stored in the memory. The computer executable components can include: a computing component that encodes at least two recurrent neural networks (RNNs) with respective time series data and determines at least two decoded RNNs based on at least two temporal context vectors, to determine temporal dependencies in at least two time series data; a combining component that combines the at least two decoded RNNs and determines an inter-time series dependence context vector and an RNN dependence decoder; and an analysis component that determines inter-time series dependencies in the at least two time series data and forecast values for one or more time series data based on an RNN encoder and the RNN dependence decoder with an attention mechanism based neural network.

According to one or more example embodiments, a computer-implemented method is provided. The computer-implemented method includes: encoding, by a computing component operatively coupled to the processor, at least two RNNs with respective time series data and determines at least two decoded RNNs based on at least two temporal context vectors, to determine temporal dependencies in the at least two time series; combining, by a combining component operatively coupled to the processor, the at least two decoded RNNs and determines an inter-time series dependence context vector and an RNN dependence decoder; and determining, by an analysis component operatively coupled to the processor, forecast values for one or more time series data based on an RNN encoder and the RNN dependence decoder with an attention mechanism based neural network.

According to yet one or more example embodiments, a computer program product is provided. The computer program product can include a computer readable storage medium having program instructions embodied therewith. The program instructions can be executable by a processor to cause the processor to: encode, by a computing component operatively coupled to the processor, at least two RNNs with respective time series data and determines at least two decoded RNNs based on at least two temporal context vectors, to determine temporal dependencies in the at least two time series; combine, by a combining component operatively coupled to the processor, the at least two decoded RNNs and determines an inter-time series dependence context vector and an RNN dependence decoder; and determine, by an analysis component operatively coupled to the processor, inter-time series dependencies in the at least two time series data and forecast values for one or more time series data based on an RNN encoder and the RNN dependence decoder with an attention mechanism based neural network.

### BRIEF DESCRIPTION OF THE DRAWINGS

FIG. 1 shows a block diagram of an example, non-limiting system for the dynamic discovery of dependencies among multivariate time series data employing neural networks, in accordance with one or more embodiments described herein.

FIG. 2 shows a schematic diagram of example manufacturing environment in which aspects of the disclosed model can be employed for neural network-based discovery of dependencies among multivariate time series data, in accordance with one or more embodiments described herein.

FIG. 3 shows diagrams of an example networking environment in which aspects of the disclosed model can be employed for neural network-based discovery of dependencies among multivariate time series data, in accordance with one or more embodiments described herein.

FIG. 4 shows diagrams of example neural network architectures that can be employed by a computing component and an analysis component of the disclosed model, in accordance with one or more embodiments described herein.

FIG. 5 shows an example diagram for a model that can be used by a computing component, a combining component, and an analysis component for the dynamic discovery of temporal and inter-dependencies among multivariate time series data, in accordance with one or more embodiments described herein.

FIGS. 6A and 6B show other example diagrams of a model for neural network-based discovery of temporal and inter-dependencies among multivariate time series data, in accordance with one or more embodiments described herein.

FIG. 7 shows an example diagram of inter-dependencies in variables determined by an analysis component of the model from multi-variate data obtained from sensors at a manufacturing plant, in accordance with one or more embodiments described herein.

FIG. 8 shows an example diagram of a sensor interaction graph generated by an analysis component of the model from multi-variate data obtained from sensors at a manufacturing plant, in accordance with one or more embodiments described herein.

FIG. 9 shows an example diagram of forecasted sensor values generated by an analysis component of the model from multi-variate data obtained from sensors at a manufacturing plant, in accordance with one or more embodiments described herein.

FIG. 10 shows an example diagram of forecasted values generated by the model from a rule-based synthetic dataset, in accordance with one or more embodiments described herein.

FIG. 11 shows an example diagram of analysis component generated temporal and inter-dependencies in the rule-based synthetic dataset as determined by the model, in accordance with one or more embodiments described herein.

FIG. 12 shows a diagram of an example flowchart for operating aspects of disclosed AI systems and algorithm, in accordance with one or more embodiments described herein.

FIG. 13 illustrates a block diagram of an example, non-limiting operating environment in which one or more embodiments described herein can be facilitated.

FIG. 14 depicts a cloud computing environment in accordance with one or more embodiments described herein.

FIG. 15 depicts abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Multivariate time series modeling and forecasting can refer to an aspect of machine learning. In some aspects, time series modeling can involve the determination of an appropriate model and then training the model based on a collection of historical data such that the model is able to determine the structure of the time series. Further, the selection and training of the model can be validated through measuring a prediction accuracy of the model for future values observed from the time series. In some aspects, the task of predicting future values by understanding data in the past can be referred to as time series forecasting.

Modeling and predicting multivariate time series in a dynamic (e.g., time-varying) environment can be more challenging than static environments where assumptions can be readily made regarding the relationships among the time series, and such assumptions can be stable and persistent throughout the life of time series. In more complex dynamical systems, the time series inter-dependency can vary in time. In such fields, entities can not only be interested in a model with high forecasting accuracy, but can want to gain deeper insights into the mutual impact and influence among the various time series datasets at given time points. Alternative or conventional approaches can lack the capability of capturing the dynamic changes in the mutual interaction among time series.

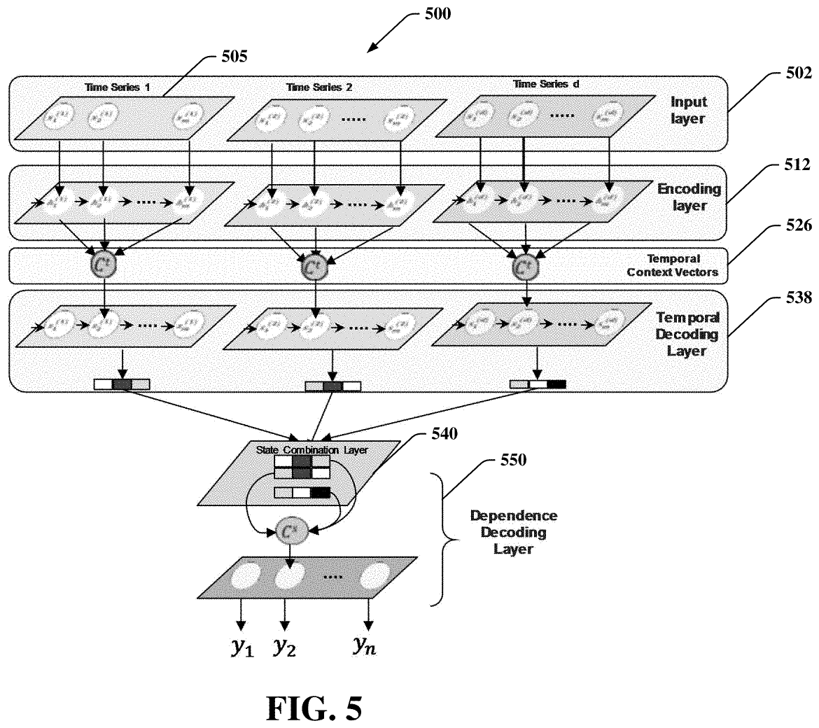

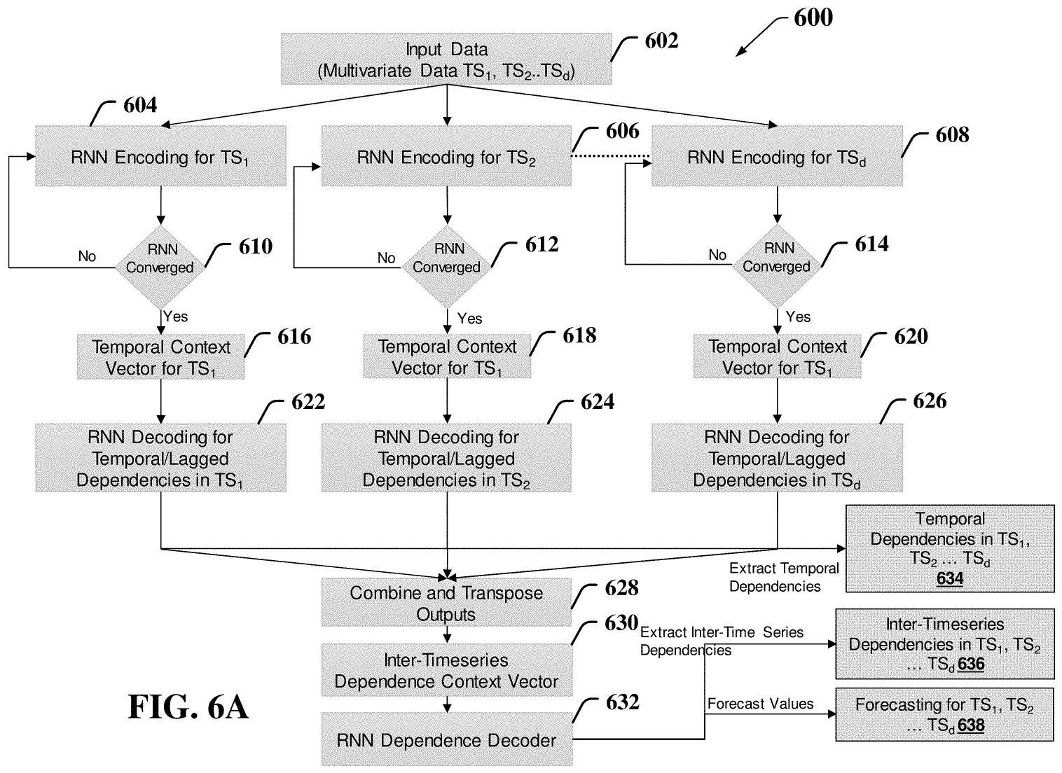

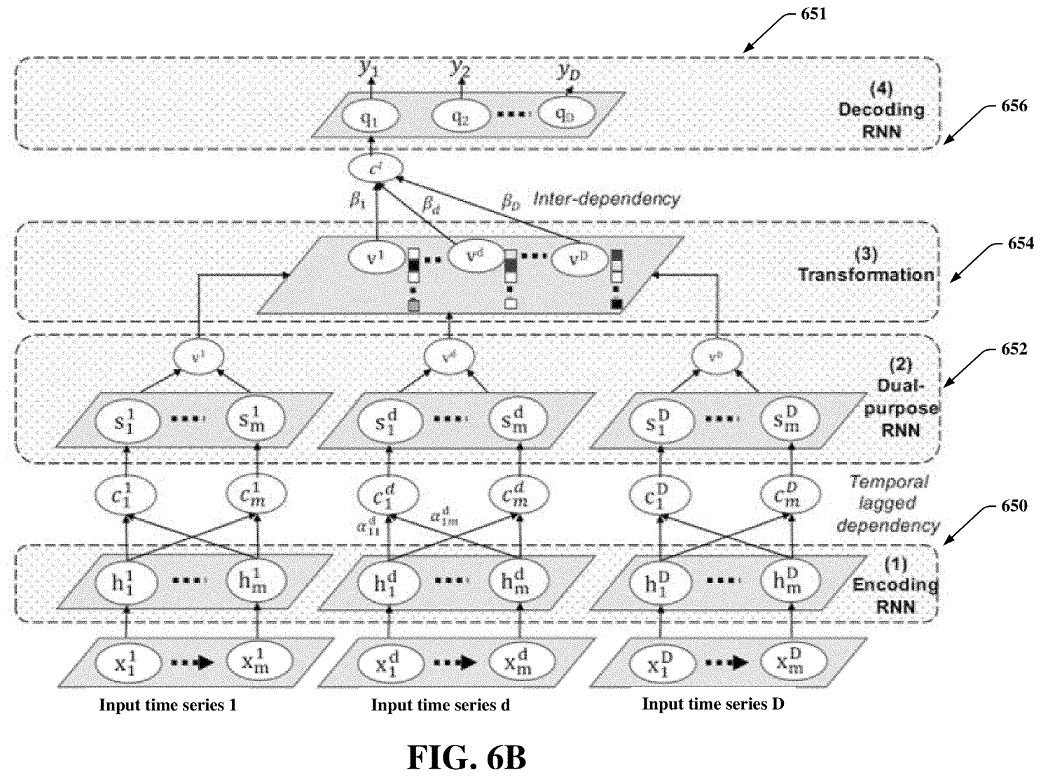

As will be described in further detail below, in some embodiments, the disclosed embodiments can include a two-layer model that can receive multivariate time series data (e.g., multiple vectors, each vector comprising a given time series data). The time series data can correspond to data received from any suitable source, such as manufacturing plant sensor data or web services data from one or more networks and associated devices. In a first layer, the model can encode recurrent neural networks (RNNs) with the respective time series data. Further, a computing component of the model can allow the RNNs to run until the model generates converged RNNs. The model can then determine temporal context vectors for the times series data based on the converged RNNs. The context vectors can be used in one or more calculations in the model, to be described in connection with FIGS. 5 and 6, below. Further, an attention mechanism can be can be implemented and/or extracted using alpha and beta scales shown in equation herein and in connection with the model and corresponding architecture disclosed herein. Accordingly, the model can extract temporal dependencies in the time series data. In a second layer, the model can combine and transpose the decoded converged RNNs for the time series. The model can further determine an inter-time series dependence context vector and determine an RNN-dependent decoder. Using this determined inter-time series dependence context vector and RNN-dependent decoder, the model can extract inter-time series dependencies in the data and forecast values for the time series data.

In some aspects, embodiments of the disclosure can allow for both inter-dependencies among time series data and the temporal lagged dependencies within each or, in some embodiments, one or more, time series data to be determined and predicted at future times. The determination of such patterns can be useful in environments where the influence among time series data is dynamic and temporally varied by nature. Embodiments of the invention can help entities (e.g., hardware/software machines and/or domain experts, who can have little or no machine learning expertise), to validate and improve their understanding about the time series. Further, embodiments of the disclosure can enable entities to make real-time decisions (e.g., predictive maintenance decisions to repair a device or service) by investigating the device or service that generates the appropriate time series and at respective temporal time points. Further, embodiments of the disclosure can enable entities to identify early performance indicators of a system, service or process, for the purpose of resource management and resource allocation, or for entering/existing investment positions (e.g. using time series on sales or sentiment polarity on a company to predict its stock price). As used herein, the term “entity” can mean or include a hardware or software device or component and/or a human, in various different embodiments. Embodiments of the disclosure can enable the discovery of time-varying inter-dependencies among time series involved in a given dynamic system that generates the multivariate time series. In particular, embodiments of the disclosure can employ a deep learning architecture; further, the deep learning architecture can be built upon or integrate with a multi-layer customized recurrent neural network. The deep learning architecture can be used to discover the time varying inter-dependencies and temporal dependencies from a given multivariate time series. By means of varied inter-dependency, the disclosed model can discover the mutual impact among time series at future predictive time points. Such a mutual relationship can vary over time as the multivariate series evolves. In addition to discovering the varied temporal dependency, the disclosed model can discover the time-lagged dependency within each individual time series. Collectively, these two sources of discovered information can be used by the model to forecast future values of the time series and can offer insights that can be used in providing explanation mechanisms about the dynamic time series. In some embodiments, one or more time series can be forecasted and/or one or more future values of one or more time series can be forecasted.

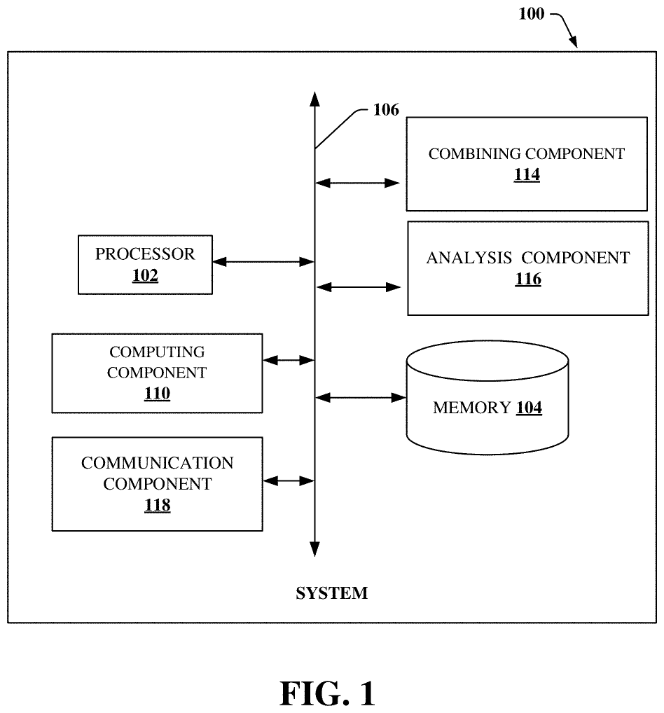

FIG. 1 illustrates a block diagram of an example, non-limiting system 100 for providing multivariate time series data analysis (e.g., discovering temporal and time-lagged dependency in the data), in accordance with one or more embodiments described herein.

System 100 can optionally include a server device, one or more networks and one or more devices (not shown). The system 100 can also include or otherwise be associated with at least one processor 102 that executes computer executable components stored in memory 104. The system 100 can further include a system bus 106 that can couple various components including, but not limited to, a computing component 110, a combining component 114, and an analysis component 116 that are operatively coupled to one another.

Aspects of systems (e.g., system 100 and the like), apparatuses or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described. Repetitive description of like elements employed in one or more embodiments described herein is omitted for sake of brevity.

The system 100 can be any suitable computing device or set of computing devices that can be communicatively coupled to devices, non-limiting examples of which can include, but are not limited to, a server computer, a computer, a mobile computer, a mainframe computer, an automated testing system, a network storage device, a communication device, a web server device, a network switching device, a network routing device, a gateway device, a network hub device, a network bridge device, a control system, or any other suitable computing device. A device can be any device that can communicate information with the system 100 and/or any other suitable device that can employ information provided by system 100. It is to be appreciated that system 100, components, models or devices can be equipped with a communication component 118 that enable communication between the system, components, models, devices, etc. over one or more networks (e.g., over a cloud computing environment).

As noted, in some embodiments, the system 100 can implement a model that can receive multivariate time series data (e.g., multiple vectors, each vector comprising a given time series data, e.g., a sequential series of numbers that are dependent on time). In some embodiments, the multivariate time series data can be received from a data collection component (not shown). In some aspects, the data received by the data collection component can be prestored in a memory component 104.

In some aspects, the computing component 110, can encode RNNs with the respective time series data. The encoding of the RNN can involve inputting the data to the input states of the RNN and setting any relevant parameters associated with the RNN (e.g., a number of iterations, a error technique, etc.) which can be determined empirically.

Further, the computing component 110 can allow the RNNs to execute until the model generates converged RNNs. This can be performed by determining when a metric associated with the RNN (e.g., a root-mean-square error (RMS) or the like) has fallen below a pre-determined threshold.

The computing component 110 can then determine temporal context vectors for the times series data based on the converged RNNs. The context vector is calculated in equation 7 and temporal attention alpha is computed in equation 6.

Further, the computing component 110 can determine decoded converged RNNs based on the temporal context vectors to determine temporal and lagged dependencies in the time series. The context vector is calculated in equation 7 and temporal attention alpha is computed in equation 6. The encoder and decoder RNNs are trained concurrently and jointly so once they are trained dependencies can be extracted.

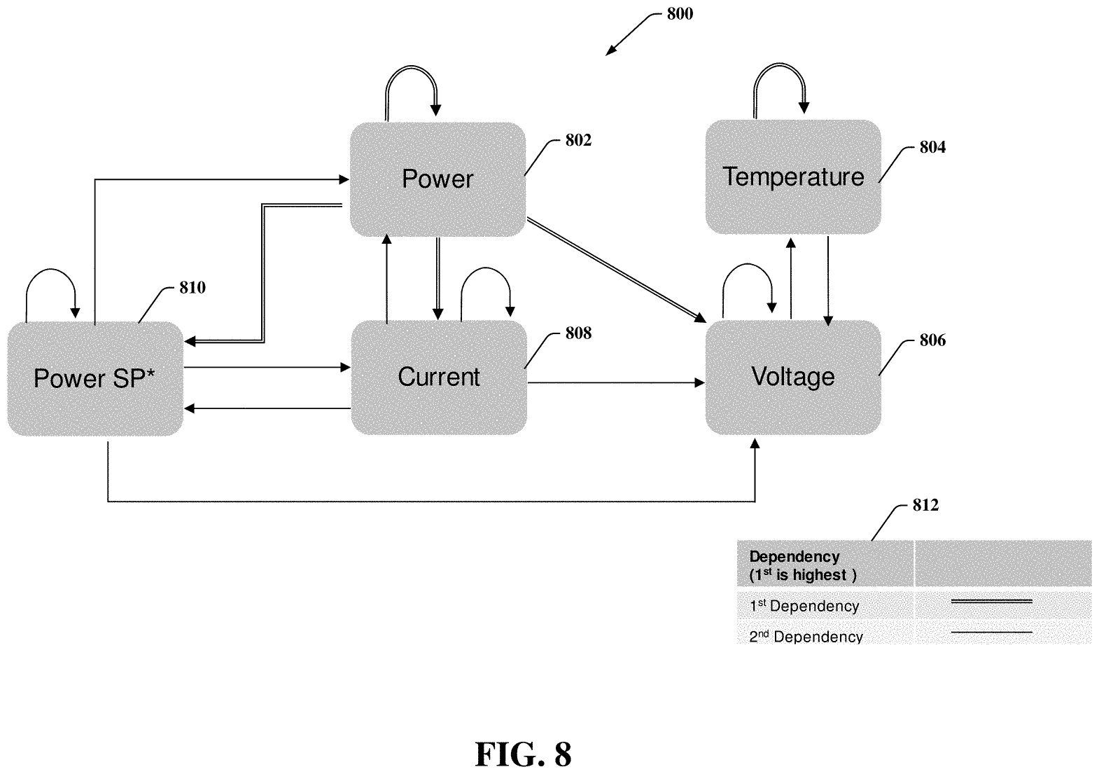

Accordingly, the computing component 110 can extract temporal dependencies in the time series data. The temporal dependencies are extracted (once the RNNs converge) using alpha shown in equation 7. This alpha can be used to draw dependency graphs (e.g., sensor interaction graph shown and described in connection with FIG. 8, below). As the new input comes the alpha can be extracted at run time thus giving dynamically changing dependency information.

In some aspects, the combining component 114 can combine and transpose the decoded converged RNNs for the time series. The analysis component 116 can further determine an inter-time series dependence context vector and determine an RNN-dependent decoder. The context vector is calculated in equation 11 and inter-time series attention beta is computed in equation 10

Using this determined inter-time series dependence context vector and RNN-dependent decoder, the analysis component 116 can extract inter-time series dependencies in the data and forecast values for the time series data. The inter-time series dependencies are extracted (once the RNNs converge) using beta shown in equation 11. This beta can be used to draw dependency graphs. As the new input comes the beta can be extracted at run time thus giving dynamically changing dependency information.

In some embodiments, the computing component 110 can use gated recurrent units (GRUs) in a recurrent neural networks (RNNs) for capturing long term dependency (e.g., long-term trends in stock market time series data over an entity-determined time-window) in the sequential data (e.g., the multivariate time series data). Such GRUs can be less susceptible to the presence of noise in the data and can be used for learning and training on both linear and nonlinear relationships in the time series. In one aspect, the system 100 does not input the time series into a single regression model (e.g., recurrent neural network). Instead, the disclosed embodiments can include a model that can encode, for example, via the computing component 110, each time series by a stand-alone GRU network. Further, the combining component 114 in combination with the analysis component 116 can input and decode the time series to discover the temporally-lagged dependencies within each time series. These decoding sequences can be subsequently used, by the computing component 110, as the encoding vectors for the next hidden layer in the RNN, which can be used by the system 100 to discover the inter-dependency among numerous time series. In such an approach, embodiments of the disclosure do not necessarily have the burden of learning the complexity of both temporal-lagged relationship and inter-dependencies of the data in a black-box model; instead the model can learn the dependencies in sequence (e.g., the model can first learn the temporally-lagged relationships in the data, and then then afterwards learn the inter-dependencies of the data). In some embodiments, this sequential learning of the dependencies can mirror aspects of the hierarchical nature of human attention. That is, the sequential learning can include first understanding the interaction among time series at a high level, and thereafter determining one or more temporal lags within each time series at a second, lower level. The performance of the model can be demonstrated on both controlled synthetic data and real-world multivariate time series, for example, from manufacturing systems which exhibit dynamic and volatile features in their respectively generated datasets.

In some embodiments, the communication component 118 can obtain time series data from one or more networks (e.g., the cloud). For example, the communication component 118 can obtain time series data from one or more devices in a manufacturing plant that are at least partially connected in a cloud environment. In another aspect, the communication component 118 can obtain time series data from one or more devices on a computational network (e.g., mobile devices, hubs, databases, and the like), that are at least partially connected in a cloud environment.

The various components (e.g. the computing component 110, the combining component 114, the analysis component 116, and/or other components) of system 100 can be connected either directly or via one or more networks (e.g., through the communication component 118. Such networks can include wired and wireless networks, including, but not limited to, a cellular network, a wide area network (WAN) (e.g., the Internet), or a local area network (LAN), non-limiting examples of which include cellular, WAN, wireless fidelity (Wi-Fi), Wi-Max, WLAN, radio communication, microwave communication, satellite communication, optical communication, sonic communication, or any other suitable communication technology. Moreover, the aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components can be combined into a single component providing aggregate functionality. The components can also interact with one or more other components not specifically described herein for the sake of brevity, but known by those of skill in the art.

Further, some of the processes performed can be performed by specialized computers for carrying out defined tasks related to various types of neural networks in their particular context. The subject computer processing systems, methods apparatuses and/or computer program products can be employed to solve new problems that arise through advancements in technology, computer networks, the Internet and the like.

Embodiments of devices described herein can employ artificial intelligence (AI) to facilitate automating one or more features described herein. The components can employ various AI-based schemes for carrying out various embodiments/examples disclosed herein. To provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system, environment, etc. from a set of observations as captured via events and/or data. Determinations can be employed to identify a specific context or action, or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence can be employed. Classification as used herein also is inclusive of statistical regression that is utilized to develop models of priority.

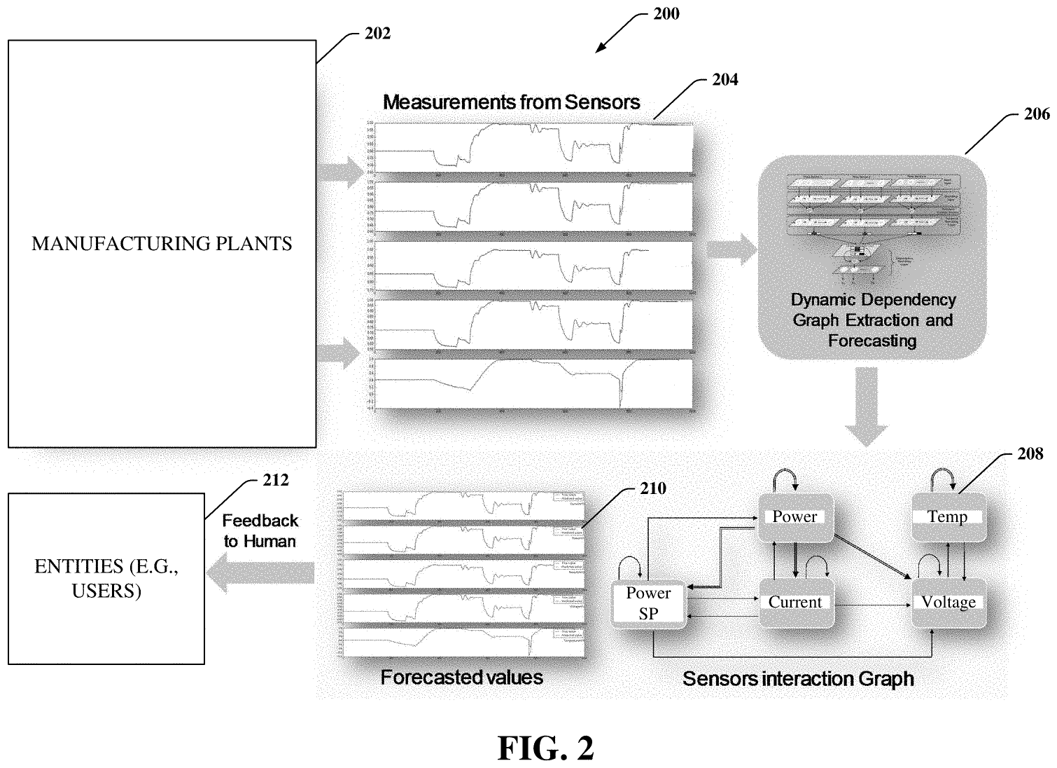

FIG. 2 shows a schematic diagram of example manufacturing environment in which aspects of the disclosed model can be employed for neural network-based discovery of dependencies among multivariate time series data, in accordance with one or more embodiments described herein.

In one example environment, embodiments of the disclosure can be used in the context of manufacturing plants 202, such as manufacturing plants used for the fabrication of complex electronic devices. In particular, in the manufacturing plants 202, a manufacturing pipeline can be used, such that a product (e.g., a chip or other computer component) can be iteratively processed as it goes through different components of the manufacturing pipeline. Further, one or more embodiments of the invention can obtain measurement data from one or more sensors situated in different parts of the manufacturing pipeline; such measurement data can have dependencies among the measurement data which can signify and correlate with certain physical process occurring in the manufacturing pipeline.

As noted, such manufacturing plants 202, there can be several sensors that can collect information from various machines and processes in the manufacturing plant 202. Such sensors can monitor variables such as temperature, power, current, voltage, pressure, and the like at various points in the manufacturing plant and generate multivariate time series data from such measurements 204.

The measurements 204 can be inputted into the disclosed model 206. In some embodiments, the model 206 can extract dynamic dependencies in the multivariate time series data in the measurements 204, and can further forecast future values in the time series data, as shown, for example, in the context of FIG. 6A step 638.

In another aspect, a device (e.g., a computer) running the model 206 can receive output from an analysis component (similar to analysis component 116 of FIG. 1) and output a sensors interaction graph 208 that plots the various relationships and the strength of those relationships between the monitored variables (e.g., temperature, power, current, voltage, pressure, and the like). The analysis component can use the model 206 to further generate forecasted values 210, which can represent future values for the multivariate time series data (e.g., a future temperature, power, current, voltage, pressure, and the like). The forecasted values are computed at 651 component shown in FIG. 6B and equation 13 can be used to calculate the future values. Equation 13 is used by a GRU component of the model used in the disclosed embodiments, but equation 13 can change based on the RNN model used in implementing the system. Accordingly, equation 13 can represent one way of calculating and forecasting future values.

In some embodiments, the sensor interaction graph 208 and/or the forecasted values 210 can be used to provide feedback 212, for example, to an entity or human operator. Moreover, changes in dependencies between sensor data can be an indication of changes in the manufacturing process. For example, changes in the dependencies can result from a worn-out part used by machines in the manufacturing process. Such a worn-out part can cause one or more other parts to try to compensate for the deficiency in the worn-out part. For example, a cooling system can begin to operate earlier than usual to counteract overheating of a faulty part. Such interactions can be detected by the disclosed model and can be brought to the attention of an entity. For example, a computer running the model can provide a corresponding message, graph, or image associated with the interactions on a device (e.g., a mobile device) associated with the entity.

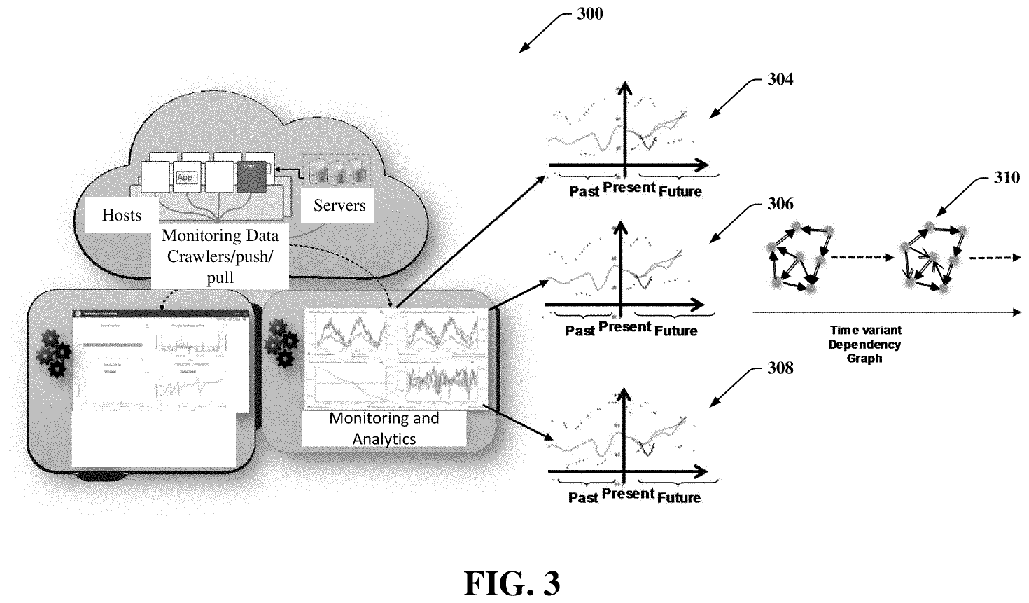

FIG. 3 shows diagrams of an example networking environment in which an analysis component of the disclosed model can be employed for neural network-based discovery of dependencies among multivariate time series data, in accordance with one or more embodiments described herein.

In particular, embodiments of the disclosure can be used in the context of monitoring metrics of various computing components (e.g., central processing units (CPUs), network throughput, memory read/write operations, and the like). In some embodiments, the monitoring can be performed at an application level as well as infrastructure level, and monitored variables can have inherent dependencies with one another. For example, the monitoring can lead to a determination that the network traffic spikes before a CPU is utilized at a higher clock speed. In another aspect, in production systems, some monitoring values can be available for monitoring before other variables. For example, a network usage metric can be available before the CPU usage values are determined using a network crawler. Such dependencies (including lagged dependencies) The lagged dependencies are dependencies of a time series value (e.g., current or future) on historical values of one or more time series. They can be hard to determine in a multivariate setting where lagged dependencies of more than one time series affect the values of another time series.

As noted, in such a network environment 302, one or more hosts and database servers can determine multivariate time series data from one or more sources. For example, one set of time series data 304 determined from the network environment 302 can include CPU utilization over time. Another set of time series data 306 determined from the network environment 302 can include network utilization over time. A third set of time series data 308 determined from the network environment 302 can include disk read-write utilization over time. One or more embodiments of the invented model can take the various time series data (e.g., the first, second, and third sets of time series data 304, 306, and 308, and the like), and determine a time-variant dependency graph 310. A time variant dependency graph (e.g., a sensor dependency graph shown and described in connection with FIG. 8) for showing relationships in lagged dependencies can be generated using alpha in equation 7 and beta in equation 11. As additional inputs are fed into the model, the alpha and beta can be extracted at run time, thus yielding dynamically-changing dependency information about the time series data. This time-variant dependency graph 310 can show the interrelationships and dependencies between the varies time series data both between data sets and within the data sets themselves. Such dependencies (including lagged dependencies) can be used, for example, in providing performance management, including resource utilization management and providing outage warnings. For instance, if the analysis component (similar, but not necessarily identical to, analysis component 116 of the model), determines that there will be a large use of the CPU that would likely lead to a power outage in the future, the analysis component may provide feedback to one or more entities so that the entities can take protective steps for the network.

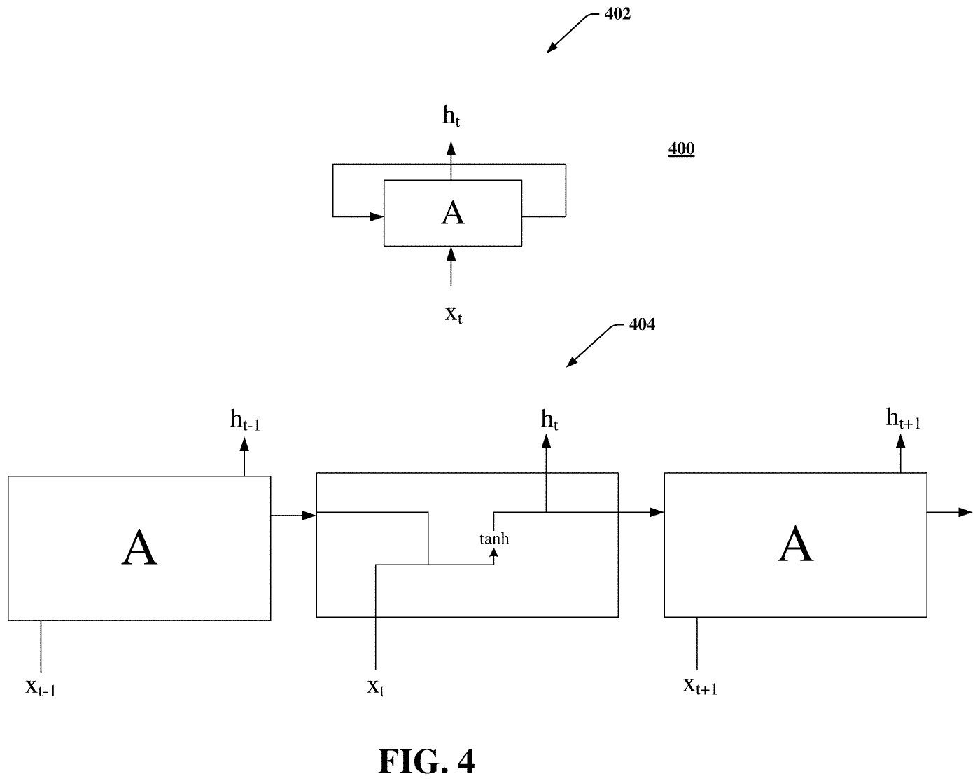

FIG. 4 shows diagrams of example neural network architectures that can be employed by a computing component and an analysis component of the disclosed model, in accordance with one or more embodiments described herein.

In particular, an RNN can involve a particular type of neural network where connections between units can form a directed graph along a given sequence of the neural network. In some embodiments, as shown in RNN 402, the neurons of the RNN can feed information back to the RNN.

Further, in a sequence of RNN cells 404, the cells can further feed information to other neurons in the network (in addition to noted feedback mechanism). In some embodiments, the disclosed model (described in the context of FIGS. 5 and 6) can use long-short term memory (LSTM) and gated recurrent units (GRUs), which can be considered a type of RNNs that include a state-preserving mechanism through built-in memory cells (not shown). Such LSTMs and GRUs can be used in multi-variate time series data analysis and forecasting, as will be described herein with reference to FIGS. 5 and 6. In some aspects, the GRU can be used as a gating mechanism for the RNNs.

In another aspect, the model described herein in connection with FIGS. 5 and 6 can include an attention mechanism that can be used in the neural networks, which can be loosely based on the visual attention mechanism found in humans, and will be described further in connection with FIGS. 5 and 6. In particular, in the context of neural machine translation (NMT), an encoder-decoder architecture can be used to generate attention vectors for the text/sentences and the attention vectors can assign higher weights to the words in a sentence that are more important in order to rightly translate a particular word. Such an attention mechanism can be useful in understanding the neural network's decision behavior, for example it can be used to generate the probabilities for words to be translated into their possible translations. Similarly, the attention mechanism can be used by the analysis component and the computing component of the model described herein to determine time-varying time-lagged and inter-dependencies among the inputted multivariate time series data.

FIG. 5 shows an example diagram for a model that can be used by a computing component, a combining component, and an analysis component for the dynamic discovery of temporal and inter-dependencies among multivariate time series data, in accordance with one or more embodiments described herein. In particular, diagram 500 shows a multi-layer RNNs having a two-level attention mechanism (to be described below) to capture time-varying time-lagged and inter-dependencies among time-series. An input layer 502 can receive one or more times series data, for example, time series data 505. The input layer 502 can feed into an encoding layer 512, where the time series data is encoded into the RNN's hidden states (e.g., parameters associated with the RNN, and where the hidden state is computed based on the current value of the time series and the previous hidden state in the RNN), as described herein. The encoding layer 512 can then feed into a temporal context vector determination layer 526, where temporal context vectors can be determined. The temporal context vector is further described in mathematical terms in connection with FIG. 6B and related discussion, below. The temporal context vector in layer 536 can be determined through the comparison between the hidden state of the temporal decoding RNN in layer 538 and each of hidden states learnt by encoding RNN in layer 526, which can represent an attention mechanism in the model. Based on this attention mechanism, the temporal lagged dependencies of the time series data can be determined for each set of time series data in the multi-variate time series data inputted into the input layer 502. The outputs of the temporal decoding layer 538 for each set of time series data (for example, time series data 505 in addition to the other times series data) can be fed into state combination layer 540. The state combination layer 540 can combine the time series data and interact with a dependence decoding layer 550 to determine dependencies among the different time series.

As noted, the RNN-based model employing aspects of the RNNs described in connection with FIG. 4, above, can have an attention mechanism that can be used to learn temporal dependencies within each time series (e.g., via a first attention level mechanism at a temporal context vector determination layer 526), and dependencies among time series (e.g., via a second attention level mechanism at the state combination layer 540 and more broadly, at the dependence decoding layer 550). The output of the RNN can be used, for example, in forecasting future values, for example, by graphing the output of an analysis component 116 of one or more of the time series data as described in connection with FIGS. 6A and 6B.

In some embodiments, both attention layers, along with the encoding layer 512, can be trained concurrently to discover dependencies among time series data.

In some embodiments, for predicting a future value of a time series, the weights for the RNN-based model involved in the second attention level mechanism can enable the determination of how much information from each time series contributes to a given prediction. The beta in equation 11 controls information used as input to the context vector regarding certain time series in the system FIG. 6B.

In another aspect, the weights for the RNN-based model involved in first attention level mechanism can enable the determination of which past values in each of the constituted time series are important for a given prediction. In some embodiments, such dependencies can be varied for each future predicted value in a given group of time series data.

FIGS. 6A and 6B show other example diagrams of a model for neural network-based discovery of temporal and inter-dependencies among multivariate time series data, in accordance with one or more embodiments described herein. In particular, as shown in FIG. 6A diagram 600, the input data can be received at 602, for example, at a data collection component. In some embodiments, the input data can represent multivariate data that can be represented as a first time series (TS1), a second time series (TS2), and so on, through a d-th time series (TSd), where d is a positive integer. At 604, TS1 can be encoded by the RNN-based model. Similarly, at 606, TS2 can be encoded by a computing component of the RNN-based model (similar to the computing component 110 of FIG. 1), and so on, such that at 608, TSd can be encoded by the computing component of the RNN-based model. At 610, it can be determined by the computing component whether the RNN-based model has converged or not (and similarly, for operations 612 involving TS2, up through operation 614 involving TSd), all the RNNs in the system can also be trained concurrently and jointly. At 616, a temporal context vector can be determined by the computing component for TS1. Similarly, at 618, a temporal context vector can be determined by the computing component for TS2, and so on, such that at 620, a temporal context vector can be determined for TSd. At 622, the RNN-based model can use the temporal context vector for TS1 by the computing component to decode the temporal and lagged dependencies in TS1. Similarly, at 624, the computing component of the RNN-based model can use the temporal context vector for TS2 to decode the temporal and lagged dependencies in TS2, and so on such that at 626 the computing component of the RNN-based model can use the temporal context vector for TSd to decode the temporal and lagged dependencies in TSd. At 628, the combining component of the RNN-based model can combine and transpose the outputs (e.g., the decoded temporal dependencies of each respective time-series) from the previous operations 622, 624, up through 626. In another aspect, the outputs (e.g., the decoded temporal dependencies of each respective time-series) from the previous operations 622, 624, up through 626 can be used, by the analysis component of the RNN-based model to extract the temporal dependences and output the results, for example, to a entity, at operation 634. Alternatively or additionally, at 630, the outputs of operation 628 (e.g., the combined and transposed outputs from previous operations 622, 624, up through 626) can be used, at 630, by the analysis component of the RNN-based model to determine the inter-time series dependence context vector. At 632, the inter-time series dependence context vector from 630 and the output of operation 628 can be used by the analysis component of the RNN-based model to (i) extract, the inter-time series dependencies in TS1, TS2, . . . TSd at 636, and (ii) to forecast future values for TS1, TS2, . . . TSd at 638.

In some embodiments, the disclosure involves a multivariate time series (MTS) system with D variables (time series members) of length T, denoted by X={x₁, x₂, . . . , x_{T}}, where each xₜ∈R^{D} is the observations or measurements of the MTS at time t. The d-th time series can be denoted by X^{d}={x₁^{d}, x₂^{d}, . . . , x_{T}^{d}}, in which xₜ^{d}∈R can represent a measurement at time t. Given such an MTS system, the MTS can be analyzed by the computing component 110 of FIG. 1 from two aspects at a given time t: (i) how the MTS's future measurements are dependent on the past values of each individual time series (e.g., temporal lagged dependencies), and (ii) how measurements of different time series are dependent on each other (e.g., inter-time series dependencies). In some embodiments, a computing component and analysis component (similar, but not necessarily identical to, computing component 110 and analysis component 116 of FIG. 1) of the model can be used to capture the time-variant dependencies to characterize the dynamically changing dependencies at any time t. Time-variant dependency discovery can be used, for example to understand and monitor the underlying behavior of a manufacturing plant or for optimizing the resource utilization in computer and storage clouds. The accuracy of time series forecasting in MTS systems can depend on how efficiently the predictors are chosen. In some embodiments, these temporal lagged and inter-dependencies can be obtained in a MTS system and these dependencies can be used to efficiently forecast future values of time series.

In some embodiments, the model can involve deep learning with RNNs. The model architecture can be used in discovering two types of dependencies, temporal lagged within each time series, and the inter-dependencies among time series, while predicting the future next values of MTS at output.

FIG. 6B shows another diagram of the overall architecture of the model, in accordance with example embodiments of the disclosure. In particular, in (1) given a multivariate time series at an input layer, an encoding RNN layer 650 can comprise a set of RNN networks, each RNN network dealing with an individual time series in the system by encoding the corresponding input time series sequence into a sequence of encoding vectors. In (2), the next dual-purpose RNN layer 652 (also referred to herein as a dual-purpose GRU layer for reasons which will be explained below) can also comprise a set of RNNs, each RNN learning the temporal lagged dependencies from one constituted time series and subsequently outputting them as a sequence of output states. In particular, a temporal context vector can be used that allows each RNN to pay attention to the most relevant temporal lagged locations in its corresponding time series, as will be described below. The alpha in equations 6 and 7 controls information from historical values going into context vector of certain time series in system FIG. 6B. The alpha can have higher values for lagged values in the time series data that highly influence the value in the output of the system, 651 in FIG. 6B. In (3), sequences of output states from the RNNs in the previous layer can be gathered together and each output state can be transformed into a higher-dimensional vector by the transformation layer 654. Such vectors can be considered as the encoding representatives of constituted time series prior to the next level of identifying inter-dependencies among series. In (4), the final decoding RNN layer 656 can discover the inter-dependencies among time series through identifying the most informative input high-dimensional vectors toward predicting the next value of each time series at the final output of the entire system. The beta in equations 10 and 11 can control information from each time series being used in the determination of the context vector in system FIG. 6B. The beta can have large values for time series data that highly impact the value in the output of the system, 651 in FIG. 6B.

The model 601 can include the following features: (i) The model 601 can employ a multi-layered approach that can use an individual RNN to learn each constituted time series at the encoding layer 650, that allows the model to discover temporal lagged dependencies within each time series. In this way, the model does not squeeze all time series into a single RNN network. (ii) Further, the model 601 can make use of a dual-purpose RNN layer 652 that decodes information in the temporal domain while concurrently encoding the information to a new feature encoding vector that promotes the discovery of inter-dependencies at the higher layers. (iii) Although the discovery of temporal-lagged and inter-dependencies can be separated at two hierarchical levels, they are tightly connected and jointly trained in a systematical way. This can allow for improved machine learning of a first type of dependency, and be used to influence the machine learning of other types of dependencies.

As noted, in some embodiments, GRUs are described, as they can be used as the RNNs in the disclosed model 601. In particular, GRUs can be similar to long-short term memory units in that GRUs capture the long-term dependencies in a sequence through a gating mechanism. In particular, there can be two gates in the GRUs, the reset gate rₜ and the update gate zₜ, which can be respectively calculated by the following equations:

rₜ=σ(Wᵣxₜ+Uᵣhₜ₋₁+bᵣ) (1)

zᵢ=σ(W_{z}xₜ+U₂hₜ₋₁+b_{z}) (2)

in which σ can represent the non-linear sigmoid function, xₜ is the input at the time point t, hₜ₋₁ is the previous hidden state of the GRU, parameters W,U, and b are respectively the input weight matrix, recurrent weight matrix, and the bias vector (subscripts are omitted for simplicity). The reset gate rₜ can control the impact of the previous state on the current candidate state \tilde{h}ₜ (equation 3, below), while the update gate zₜ controls how much of new information xₜ is added and how much of past information hₜ₋₁ is kept. Upon these, the new hidden state hₜ can be updated through a linear interpolation (equation 4, below).

ĥₜ=tan h(Wₕxᵢ+Uₕ(rₜ⊙hᵢ₋₁) (3)

hₜ=(1−z_{L})⊙hᵢ₋₁+zₜ⊙\tilde{h}ₜ (4)

In equations (3) and (4), the ⊙ operator can refer to an element-wise product, and similar to the above, Wₕ,Uₕ,bₕ can represent the GRU's parameters. The aforementioned computational steps can be simply referred to hereinafter by hₜ=GRU(xₜ,hₜ₋₁) (i.e., skipping the internal gating computations).

In some embodiments, during the training phrase, at a single time point in the multi-variate time series, the disclosed model can receive D sequences by a data collection component as inputs, each sequence of size of m and corresponding to historical time points from one component time series. The model can output, by an analysis component, a sequence or vector y={1ᵢ, . . . , y_{D}} which can represent values of the next time point of the time series. While training to map the set of input sequences to the output sequence, the model can discover temporal lagged dependencies within each component time series, and the inter-dependencies among all time series at the current timestamp. The below discussion describes the computational steps of discovering time lagged dependencies, for a specific component time series, denoted by the d index. The steps can be applicable to other time series involved in the system and model as well.

At the d-th time series, a computing component of encoding RNN layer 650 can receive a sequence of m values from the last m historical time points denoted by {x₁^{d}, x₂^{d}, . . . , xₘ^{d}}, and the computing component of the encoding RNN layer 650 can encodes the sequence into a sequence of hidden states {h₁^{d}, h₂^{d}, . . . , hₘ^{d}}, based upon another GRU (described below) along with the attention mechanism for discovering time lagged dependencies within the d-th series. The hidden states h₁^{d}, . . . , hₘ^{d} can represent or annotate the input sequence, and can allow for the determination of lagged dependencies where the recurrent process encodes past information into these hidden states. In some embodiments, when the attention mechanism is applied to continuous time series, the attention mechanism can emphasize the last hidden state and thus make it difficult for the model to identify the correct lagged dependencies. This effect can be less noticeable with language translation models manipulating on discrete words but more pronounced in case of continuous time series. Accordingly the bidirectional GRU can be used, which can allow the model to travel through the input sequence twice and exploit information from both directions, as explicitly computed by the following equation (5):

hₜ^{d}=[\vec{hₜ^{d}}, [symbol] ]=[\vec{GRU}(xₜ^{d},\vec{hₜ₋₁^{d}}), [symbol] (xₜ^{d}, [symbol] )] for t=1 . . . m (5)

In some embodiments, the disclosed model can train a corresponding GRU network in the dual-purpose RNN layer in association with the encoder RNN at the d-th time series in the previous layer. At a timestamp t, the model can compute a layer's output value vₜ^{d} (to be discussed below) based on its current hidden state sₜ^{d}, the previous output vₜ₋₁^{d} and the temporal context vector cₜ^{d}. In calculating the context vector cₜd, the GRU can generate attention weights αₜⱼ^{d}'s for j=1 . . . m for each representation vector hⱼ^{d}. While still retaining the time order among the output values, the attention mechanism can allow the disclosed model to focus on specific timestamps at which the most relevant information is located. Mathematically, we compute the following equations (6)-(9) at this dual-purpose GRU layer 652:

$$\begin{matrix}{α}_{tj}^{d} = \frac{exp ( align ( {s}_{i - 1}^{d} , {h}_{j}^{d} ) )}{{\sum }_{k = 1}^{m} exp ( align ( {s}_{t - 1}^{d} , {h}_{k}^{d} ) )} & ( 6 ) \\ {c}_{t}^{d} = {\sum }_{j = 1}^{m} {α}_{tj}^{d} {h}_{j}^{d} & ( 7 ) \\ {s}_{t}^{d} = GRU ( {υ}_{t - 1}^{d} , {s}_{t - 1}^{d} , {c}_{t}^{d} ) & ( 8 ) \\ {υ}_{t}^{d} = tanh ( {W}_{o}^{d} {υ}_{t - 1}^{d} + {U}_{o}^{d} {s}_{t}^{d} + {C}_{o}^{d} {e}_{t}^{d} + {b}_{o}^{d} ) & ( 9 )\end{matrix}$$

in which W_{O}^{d},U_{O}^{d},C_{O}^{d},b_{O}^{d} can represent the layer's parameters that need to be learned. The scalar αₜⱼ^{d} can be used to determine the temporal lagged dependencies with respect to this d-th time series, since the scalar αₜⱼ^{d} reflects the degree of importance of annotation vector hⱼ^{d} towards computing the temporal context vector cₜ^{d}, and subsequently the layer's output vₜ^{d}. The calculation of the scalar αₜⱼ^{d}. can be represented as the normalized alignment between the GRU's hidden state and each of the encoded annotation vector hⱼ^{d}, which in turns can be measured in different ways. For example, the measurement can be performed as a simple form of vector dot product align(sₜ^{d},hⱼ^{d})=(sₜ^{d})^{T}hⱼ^{d} (assuming GRUs in the two layers having the same hidden units). The measurement can also be performed by a calculation of (sₜ^{d})^{T}Wₐhⱼ^{d} (if GRUs have different hidden units numbers). Further, the computation can be performed as the general concatenation form of tan h(Wₐ[sₜ^{d};hⱼ^{d}])^{T}vₐ, where Wₐ and vₐ are jointly trained with the entire layer.

As noted, the disclosed attention mechanism at this temporal domain can follow the general idea adopted in neural machine translation (NMT), yet it can be different in at least two aspects. First, in order to deal with the continuous domain of time series, the disclosed model can use the hyperbolic tangent (tan h) function at the output. Second, ground-truth (e.g., target sentences in NMT) for the layer's output values vₜ^{d} 's can not be determined, but rather, the disclosed model can learn the ground-truth automatically. Further, the ground-truth's embedding information can directly influence the quality of learning inter-dependencies among the time series in the upper layers in the disclosed model 601. In particular, the vₜ^{d}'s can act as the bridging information between our two-level of discovering temporal lagged dependencies and inter-dependencies. Hence, the GRU layer 652 can perform two tasks at substantially same time: (i) the GRU layer 652 can decode information in the temporal domain in order to discover the most informative historical time points within each individual time series, (ii) the GRU layer 652 can encode this temporal information into a set of output values vₜ^{d} 's which, collected from all time series, form the inputs for our next layer of discovering inter-dependencies among all time series as described below. For this reason, this layer can be referred to herein as a dual-purpose RNN 652.

Following the dual-purpose RNN layer 652 above, which generates a sequence v^{d}={v₁^{d}, v₂^{d}, . . . , vₘ^{d}} at d-th input time series, a combining component of the transformation layer 654 can gather these sequences from all D constituted time series and subsequently performs a transformation step that converts each sequence into a high dimensional feature vector. These vectors can be stacked to a sequence and denoted by {v¹, v², . . . , v^{D}}. There can be no specific temporal dimension among these vectors, their order in the stacked sequence may only need to be specified prior to the training of the disclosed model. This can thereby ensure the right interpretation when the disclosed model determines the inter dependencies among time series in subsequent layers.

An analysis component of the decoding RNN layer 656 can comprise a single GRU network that performs the inter-time series dependencies discovery while also making prediction for each yᵢ at the model's output. The attention generation mechanism can be used with the following computational steps:

$$\begin{matrix}{β}_{i}^{d} = \frac{exp ( align ( {q}_{i - 1} , {v}^{d} ) )}{{\sum }_{k = 1}^{D} exp ( align ( {q}_{i - 1} , {v}^{k} ) )} & ( 10 ) \\ {c}_{i} = {\sum }_{d = 1}^{D} {β}_{i}^{d} {v}^{d} & ( 11 ) \\ {q}_{i} = GRU ( {q}_{i - 1} , {c}_{i} ) & ( 12 ) \\ {y}_{i} = tanh ( {C}_{o} {c}_{i} + {U}_{o} {q}_{i} + {b}_{o} ) & ( 13 )\end{matrix}$$

In particular, the alignment of the hidden state qᵢ₋₁ of the GRU can be computed with each of the encoding vectors v^{d} (featured for each input time series at this stage) in order to obtain the attention weight. Using these generated attention weights, the context vector cᵢ can be determined, which in turn can be used to update the current hidden state qᵢ of the GRU and altogether, the output yᵢ. As noted, C_{O} and U_{O} can represent the layer parameters to be learned. By letting yᵢ be the next value of the i-th time series, coefficient βᵢ^{d} as seen in equation (11) can be used to determine how significant the d-th time series (represented by v^{d}) is in constructing the context vector cᵢ and subsequently the predictive value yᵢ. In other words, coefficient βᵢ^{d} can reveal the dependency of i-th time series on the d-th time series at the current timestamp. In some embodiments, the closer to 1 the βᵢ^{d} is, the stronger this dependency. The vector βᵢ therefore can be used to determine the dependencies of i-th time series on the constituted time series in the system (including itself).

Accordingly, in some embodiments, the disclosed model 601 can be used to determine the temporal lagged and inter-dependencies among time series, but it can also be generally seen as performing the task of transforming multiple input sequences into one output sequence, all in the continuous numerical domain. As presented above, the output sequence is the set of values of the next timestamp in the multivariate time series, but one can easily replace the output sequence with the next n values of one time series of interest. With this latter case, equations (12) and (13) can be replaced by qᵢ=GRU(yᵢ₋₁,qᵢ₋₁,cᵢ) and yᵢ=tan h(yᵢ₋₁,C_{O}cᵢ+U_{O}qᵢ+b_{O}) in order to further explore the temporal order in the output sequence. Interpretation over the inter-dependencies based on βᵢ's vectors can remain unchanged; however, such an interpretation can be performed for the given time series and over a window of the next n future time points.

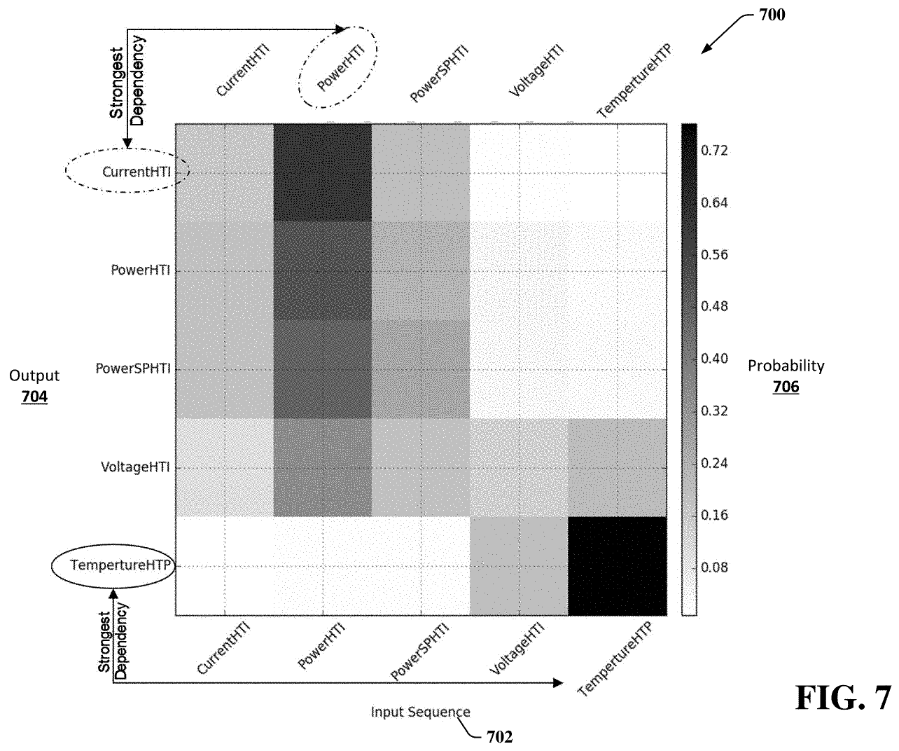

FIG. 7 shows an example diagram of inter-dependencies in variables determined by an analysis component of the model from multi-variate data obtained from sensors at a manufacturing plant, in accordance with one or more embodiments described herein. In particular, the manufacturing dataset was obtained by sensor data collected via different tools at manufacturing plant in Albany, N.Y. A sample of the dataset containing five sensors was used to test the disclosed model. In particular, diagram 700 plots different input sequences 702 corresponding to different timeseries data versus the probability 706 of the dependence of same timeseries data 704 as determined by the disclosed model (e.g., using an analysis component similar to the analysis component of FIG. 1). In some embodiments, the input sequences shown can include current, power, power set-point (SP), voltage, and temperature, respectively. Further, the probability 706 can range from approximately 0 to approximately 0.75 on a scale of 0 to 1. The diagram 700 illustrates the relationship between different data sets. For example, the temperature is most strongly dependent on the temperature itself (e.g., previous values of the temperature). Further, the diagram 700 illustrates that the current is strongly dependent on the power. Various intermediate levels of dependencies between variables is also shown.

FIG. 8 shows an example diagram of a sensor interaction graph generated by an analysis component of the model (e.g., using an analysis component similar to the analysis component of FIG. 1) from multi-variate data obtained from sensors at a manufacturing plant, in accordance with one or more embodiments described herein. In particular, the diagram 800 shows the relationships and dependencies between the power 802, temperature 804, voltage 806, current 808, and power set-point (SP) 810. For example, certain variables (e.g., current) can influence other variables (e.g., temperature) through one or more physical phenomena (e.g., through Joule heating, which can refer to the process by which the passage of an electric current through conductor produces heat) or through network effects. The diagram 800 can, in particular, show the relationship via arrows, where the arrow points in the direction from an independent variable to the corresponding dependent variable, or from a predictor variable to a predicted variable. In another aspect, legend 812 indicates the strength of the relationships between these various variables, where the strength can vary between a first level dependency (relatively strongest) to a fourth level dependency (relatively weakest). For example, it can be noted that the power 802 is most strongly influenced by itself, the power set point 810, and the voltage 806. In another example, it can be seen that the temperature 804 is most strongly affected by itself, and can further be influenced by the voltage (second level dependence). In particular, the dependency graph indicates that the system can adjust current first and then power to attain a given power SP.

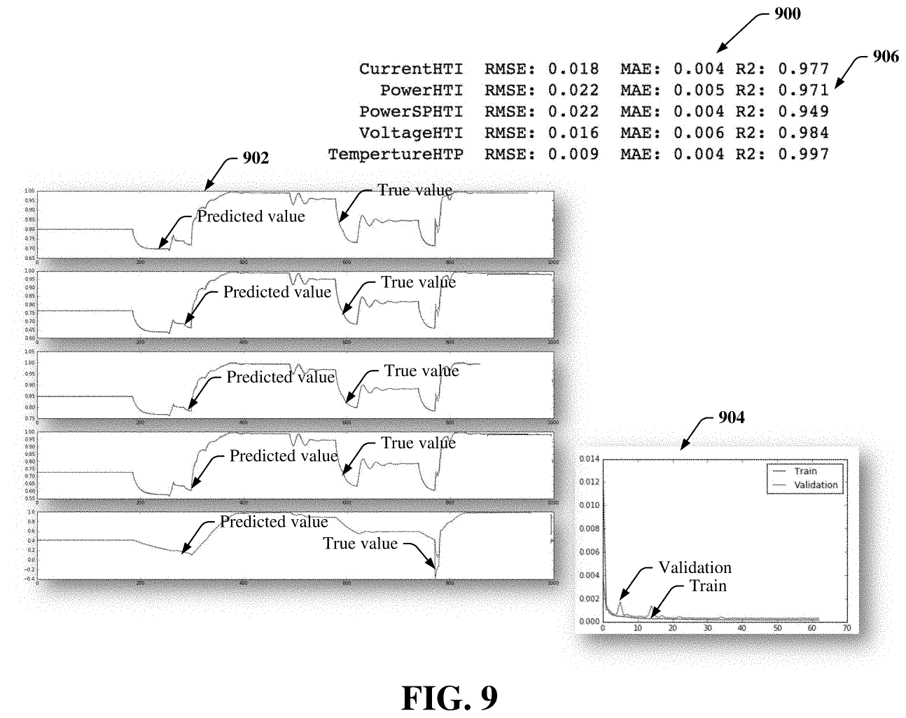

FIG. 9 shows an example diagram of forecasted sensor values generated by the analysis component of the model (e.g., using an analysis component similar to the analysis component of FIG. 1) from multi-variate data obtained from sensors at a manufacturing plant, in accordance with one or more embodiments described herein.

In particular, for the example system monitored and discussed in the context of FIG. 8, the model can further predict future values of sensor values (e.g., sensor values for power, temperature, voltage, current, and power SP). As shown in plot 902, the difference between the true value and predicted value for each of the sensor values (e.g., sensor values for power, temperature, voltage, current, and power SP) can be similar. Further, plot 904 shows that, as the model is trained, the agreement between the training and simulation increases. Moreover, as shown in table 906, various error metrics such as the root-mean square error (RMSE), the mean absolute error (MAE), and the coefficient of determination (R-squared or R2) for the predicted and actual values for the sensors (e.g., sensor values for power, temperature, voltage, current, and power SP) indicate a good fit between the predicted and actual values of the sensors. For example, the RMSE is less than 1 for the sensor values, the MAE is less than 0.01 for the sensor values, and the R2 is nearly 1 for the sensor values.

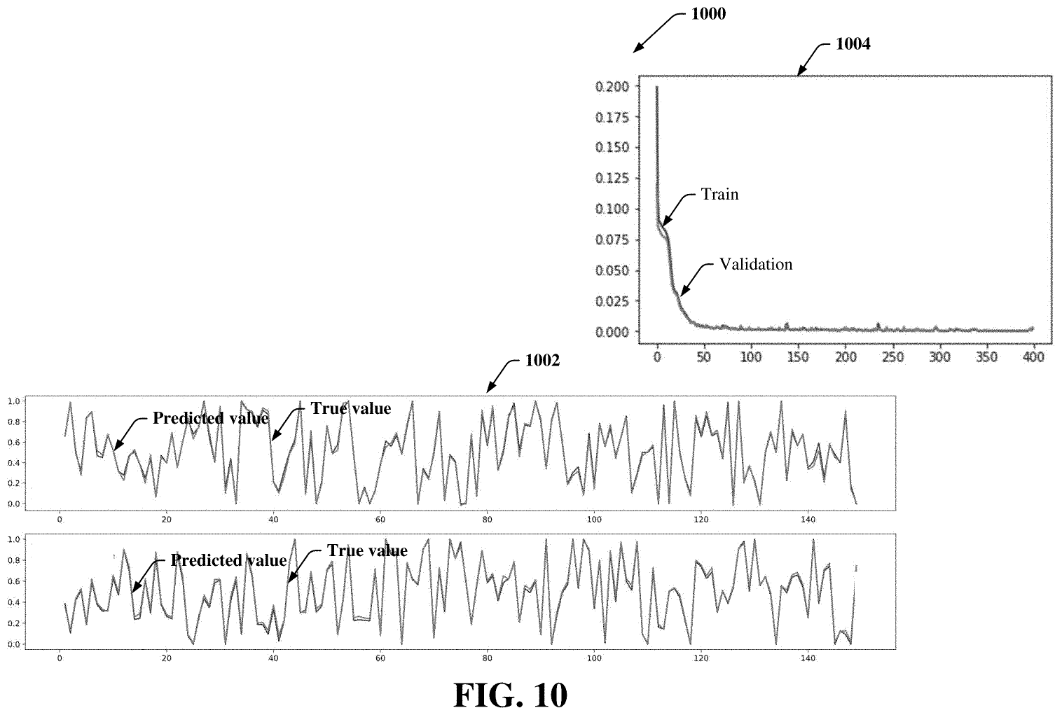

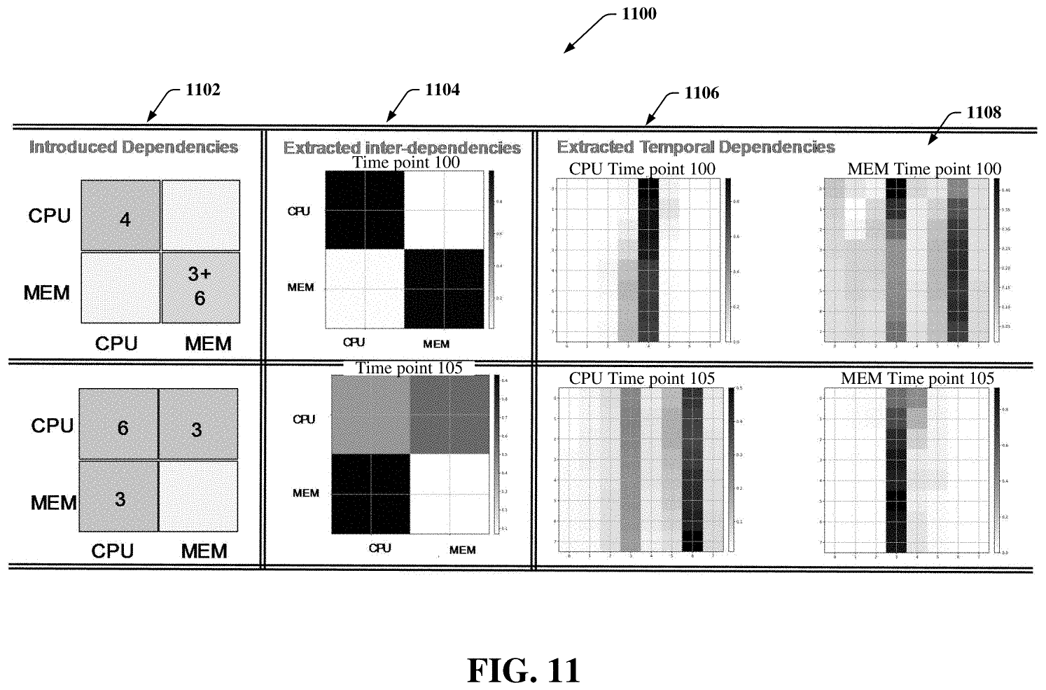

FIG. 10 shows an example diagram of forecasted values generated by the analysis component of the model from a rule-based synthetic dataset, in accordance with one or more embodiments described herein. In particular, a rule-based synthetic dataset (described below in connection with FIG. 11) can be generated in order to test and validate the capability of the disclosed model. In one aspect, the synthetic dataset can simulate cloud platform performance data. Accordingly, dependencies among different performance metric can be introduce using rules to check if the model can discover those dependencies by comparing matches between CPU times series data and corresponding predicted values from the disclosed model. Plot 1002 shows a match between the CPU time series data and corresponding predicted values (top graph), and a match between the MEM time series and corresponding predicted values (bottom graph). Further, plot 1004 shows that, as the model is trained, the agreement between the training and simulation values for predicted the future values of the time series data for the CPU and/or memory (MEM) usage increases.

FIG. 11 shows an example diagram of temporal and inter-dependencies in the rule-based synthetic dataset as determined by the model, in accordance with one or more embodiments described herein. In particular, the rules for the dependencies can be as follows: (1) If CPU(t−8)>0.5, then CPU(t)=CPU(t−6)+MEM(t−3) and (2) MEM(t)=CPU(t−3). Otherwise, (3) CPU(t)=CPU(t−4), and (4) MEM(t)=MEM(t−3)+MEM(t−6). At 1102, the introducted dependencies are shown. In particular, for the top plot, the CPU's value at time t is dependent on the CPU's value at 4 time units (TU) time units, while and the memory's value at time t is depndent on the memory's value at 3 and 4 time units before. Further, the bottom plot shows that the CPU's value at time t is dependent on the CPU's time value 6 TU's before and the memory's value 3 time units before. Further, the memory's value at time t is dependent on the CPU's value 3 time units before. As shown in plots 1104, both the top and bottom plots indicate that the model is able to correctly identify the relationship and inter-dependecies between the multivariate data series from an analysis of the synthetic data created using the above rules. Further, plots 1106 and 1108 indicate that the model is also able to extract temporal dependencies in the synthetic data generated from the above rules.

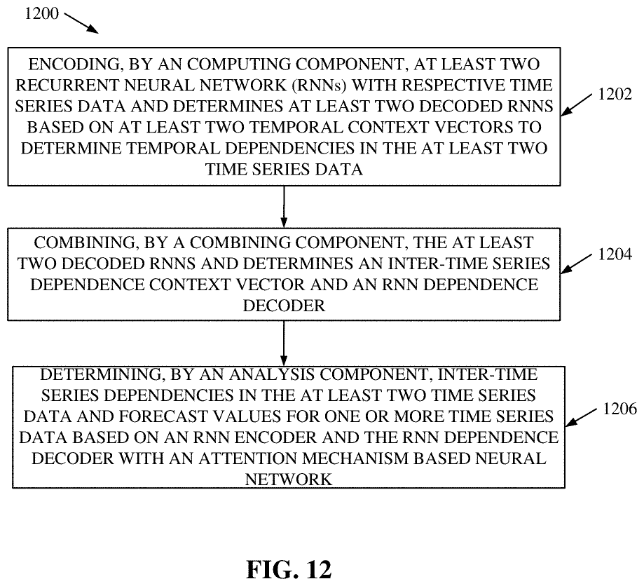

FIG. 12 shows a diagram of an example flowchart for operating aspects of disclosed AI systems and algorithm, in accordance with one or more embodiments described herein. In particular, at 1202, a processor of a computing component can be used to encode at least two RNNs with respective time series data and determines at least two decoded RNNs based on at least two temporal context vectors to determine temporal dependencies in the at least two time series data. At 1204 a combining component can combine, using the processor, the at least two decoded RNNs and determine an inter-time series dependence context vector and an RNN dependence decoder. At 1206 an analysis component can determine, using the processor, inter-time series dependencies in the at least two time series data and forecast values for the at least two time series data based on the inter-time series dependence context vector and the RNN dependence decoder.

As mentioned, the multivariate time series data and/or one or more components discussed for example, in FIG. 1 and other figures herein, can be hosted on a cloud computing platform. Further, one or more databases used in connection with the disclosure can include a database stored or hosted on a cloud computing platform. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active entity accounts). Resource usage can be monitored, controlled, and reported, providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited entity-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

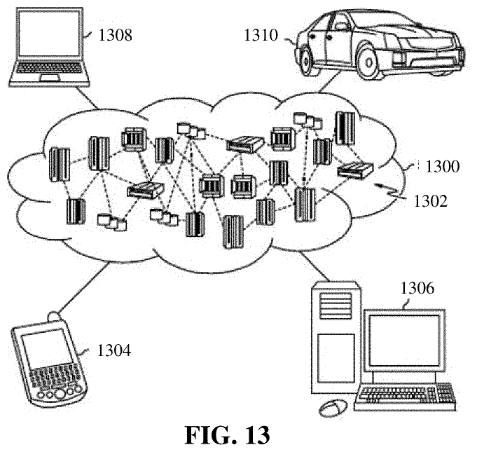

Referring now to FIG. 13, illustrative cloud computing environment 1300 is depicted. Repetitive description of like elements employed in other embodiments described herein is omitted for sake of brevity. As shown, cloud computing environment 1300 includes one or more cloud computing nodes 1302 with which local computing devices used by cloud consumers, such as, for example, personal digital assistant (PDA) or cellular telephone 1304, desktop computer 1306, laptop computer 1308, and/or automobile computer system 1310 can communicate. Nodes 1302 can communicate with one another. They can be grouped (not shown) physically or virtually, in one or more networks, such as Private, Community, Public, or Hybrid clouds as described hereinabove, or a combination thereof. This allows cloud computing environment 1300 to offer infrastructure, platforms and/or software as services for which a cloud consumer does not need to maintain resources on a local computing device. It is understood that the types of computing devices 1304-1310 shown in FIG. 13 are intended to be illustrative only and that computing nodes 1302 and cloud computing environment 1300 can communicate with any type of computerized device over any type of network and/or network addressable connection (e.g., using a web browser).

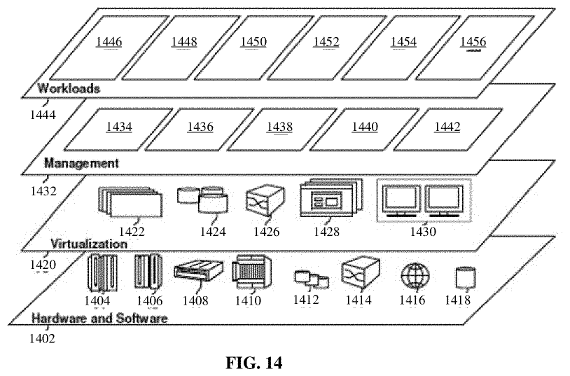

Referring now to FIG. 14, a set of functional abstraction layers provided by cloud computing environment 1300 (FIG. 13) is shown. Repetitive description of like elements employed in other embodiments described herein is omitted for sake of brevity. It should be understood in advance that the components, layers, and functions shown in FIG. 14 are intended to be illustrative only and embodiments of the invention are not limited thereto. As depicted, the following layers and corresponding functions are provided.

Hardware and software layer 1402 includes hardware and software components. Examples of hardware components include: mainframes 1404; RISC (Reduced Instruction Set Computer) architecture-based servers 1406; servers 1408; blade servers 1410; storage devices 1412; and networks and networking components 1414. In some embodiments, software components include network application server software 1416 and database software 1418.

Virtualization layer 1420 provides an abstraction layer from which the following examples of virtual entities can be provided: virtual servers 1422; virtual storage 1424; virtual networks 1426, including virtual private networks; virtual applications and operating systems 1428; and virtual clients 1430.

In one example, management layer 1432 can provide the functions described below. Resource provisioning 1434 provides dynamic procurement of computing resources and other resources that are utilized to perform tasks within the cloud computing environment. Metering and Pricing 1436 provide cost tracking as resources are utilized within the cloud computing environment, and billing or invoicing for consumption of these resources. In one example, these resources can include application software licenses. Security provides identity verification for cloud consumers and tasks, as well as protection for data and other resources. Entity portal 1438 provides access to the cloud computing environment for consumers and system administrators. Service level management 1440 provides cloud computing resource allocation and management such that required service levels are met. Service Level Agreement (SLA) planning and fulfillment 1442 provide pre-arrangement for, and procurement of, cloud computing resources for which a future requirement is anticipated in accordance with an SLA.

Workloads layer 1444 provides examples of functionality for which the cloud computing environment can be utilized. Examples of workloads and functions which can be provided from this layer include: mapping and navigation 1446; software development and lifecycle management 1448; virtual classroom education delivery 1450; data analytics processing 1452; transaction processing 1454; and assessing an entity's susceptibility to a treatment service 1456. Various embodiments of the present invention can utilize the cloud computing environment described with reference to FIGS. 13 and 14 to determine a trust disposition value associated with one or more entities and/or determine the susceptibility of the one or more entities to one or more treatment services based on the trust disposition value.

The present invention can be a system, a method, and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

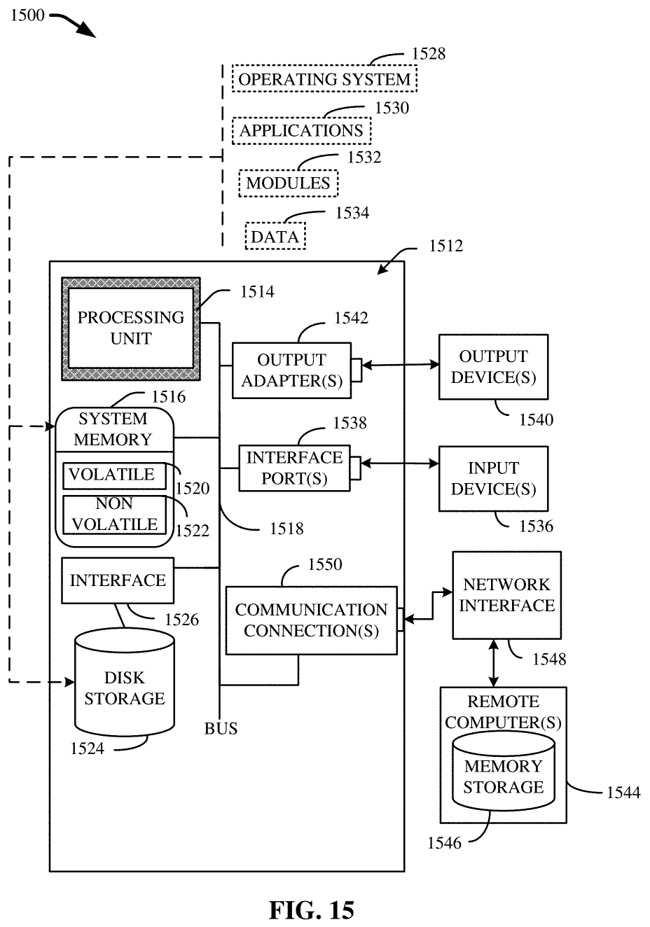

In order to provide a context for the various aspects of the disclosed subject matter, FIG. 15 as well as the following discussion are intended to provide a general description of a suitable environment in which the various aspects of the disclosed subject matter can be implemented. FIG. 15 illustrates a block diagram of an example, non-limiting operating environment in which one or more embodiments described herein can be facilitated. Repetitive description of like elements employed in other embodiments described herein is omitted for sake of brevity. With reference to FIG. 15, a suitable operating environment 1500 for implementing various aspects of this disclosure can include a computer 1512. The computer 1512 can also include a processing unit 1514, a system memory 1516, and a system bus 1518. The system bus 1518 can operably couple system components including, but not limited to, the system memory 1516 to the processing unit 1514. The processing unit 1514 can be any of various available processors. Dual microprocessors and other multiprocessor architectures also can be employed as the processing unit 1514. The system bus 1518 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 1516 can also include volatile memory 1520 and nonvolatile memory 1522. The basic input/output system (BIOS), containing the basic routines to transfer information between elements within the computer 1512, such as during start-up, can be stored in nonvolatile memory 1522. By way of illustration, and not limitation, nonvolatile memory 1522 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1520 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1512 can also include removable/non-removable, volatile/nonvolatile computer storage media. FIG. 15 illustrates, for example, a disk storage 1524. Disk storage 1524 can also include, but is not limited to, devices like a magnetic disk drive, floppy disk drive, tape drive, Jaz drive, Zip drive, LS-100 drive, flash memory card, or memory stick. The disk storage 1524 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1524 to the system bus 1518, a removable or non-removable interface can be used, such as interface 1526. FIG. 15 also depicts software that can act as an intermediary between entities and the basic computer resources described in the suitable operating environment 1500. Such software can also include, for example, an operating system 1528. Operating system 1528, which can be stored on disk storage 1524, acts to control and allocate resources of the computer 1512. System applications 1530 can take advantage of the management of resources by operating system 1528 through program components 1532 and program data 1534, e.g., stored either in system memory 1516 or on disk storage 1524. It is to be appreciated that this disclosure can be implemented with various operating systems or combinations of operating systems. A entity enters commands or information into the computer 1512 through one or more input devices 1536. Input devices 1536 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1514 through the system bus 1518 via one or more interface ports 1538. The one or more Interface ports 1538 can include, for example, a serial port, a parallel port, a game port, and a universal serial bus (USB). One or more output devices 1540 can use some of the same type of ports as input device 1536. Thus, for example, a USB port can be used to provide input to computer 1512, and to output information from computer 1512 to an output device 1540. Output adapter 1542 can be provided to illustrate that there are some output devices 1540 like monitors, speakers, and printers, among other output devices 1540, which require special adapters. The output adapters 1542 can include, by way of illustration and not limitation, video and sound cards that provide a means of connection between the output device 1540 and the system bus 1518. It should be noted that other devices and/or systems of devices provide both input and output capabilities such as one or more remote computers 1544.

Computer 1512 can operate in a networked environment using logical connections to one or more remote computers, such as remote computer 1544. The remote computer 1544 can be a computer, a server, a router, a network PC, a workstation, a microprocessor based appliance, a peer device or other common network node and the like, and typically can also include many or all of the elements described relative to computer 1512. For purposes of brevity, only a memory storage device 1546 is illustrated with remote computer 1544. Remote computer 1544 can be logically connected to computer 1512 through a network interface 1548 and then physically connected via communication connection 1550. Further, operation can be distributed across multiple (local and remote) systems. Network interface 1548 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 1550 refers to the hardware/software employed to connect the network interface 1548 to the system bus 1518. While communication connection 1550 is shown for illustrative clarity inside computer 1512, it can also be external to computer 1512. The hardware/software for connection to the network interface 1548 can also include, for exemplary purposes only, internal and external technologies such as, modems including regular telephone grade modems, cable modems and DSL modems, ISDN adapters, and Ethernet cards.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the entity's computer, partly on the entity's computer, as a stand-alone software package, partly on the entity's computer and partly on a remote computer or entirely on the remote computer or server. In the latter scenario, the remote computer can be connected to the entity's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, component, segment, or portion of instructions, which includes one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules or components. Generally, program modules or components include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules or components can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components;
a processor, operably coupled to the memory, and that executes the computer-executable components stored in the memory, wherein the computer-executable components comprise:
a computing component that encodes at least two recurrent neural networks (RNNs) with respective time series data and determines at least two decoded RNNs based on at least two temporal context vectors, to determine temporal dependencies in at least two time series data;
a combining component that combines the at least two decoded RNNs and determines an inter-time series dependence context vector and an RNN dependence decoder; and
an analysis component that determines inter-time series dependencies in the at least two time series data and forecast values for one or more time series data based on an RNN encoder and the RNN dependence decoder with an attention mechanism based neural network.

2. The system of claim 1, wherein the computer-executable components further comprise:
a data collection component that collects the at least two time series data, wherein the at least two time series data comprise multivariate time series data.

3. The system of claim 1, wherein the computing component further determines converged RNNs by iteratively encoding the at least two RNN with the respective time series data.

4. The system of claim 1, wherein the computing component encoding the at least two RNNs and the combining component combining the at least two decoded RNNs are performed jointly and concurrently.

5. The system of claim 1, wherein the RNN comprises a long-short term memory neural network.

6. The system of claim 1, wherein the RNN comprises gated recurrent units as gating mechanisms for the RNN.

7. The system of claim 1, wherein the system further comprises the attention mechanism-based neural network for the determination of the at least two temporal context vectors.

8. A system, comprising:
a memory that stores computer-executable components;
a processor, operably coupled to the memory, and that executes the computer-executable components stored in the memory, wherein the computer-executable components comprise:
a computing component that encodes at least two recurrent neural networks (RNNs) with respective time series data and determines at least two decoded RNNs based on at least two temporal context vectors, to determine temporal dependencies in at least two time series data;
a combining component that determines an inter-time series dependence context vector and an RNN dependence decoder; and
an analysis component that determines forecast values for one or more time series data based on an RNN encoder and the RNN dependence decoder with an attention mechanism based neural network.

9. The system of claim 8, wherein the computer-executable components further comprise a data collection component that collects the at least two time series data, wherein the at least two time series data comprise multivariate time series data.

10. The system of claim 8, wherein the computing component further determines converged RNNs by iteratively encoding the at least two RNNs.

11. The system of claim 8, wherein the computing component encoding the at least two RNNs and the combining component combining the at least two decoded RNNs are performed concurrently.

12. The system of claim 8, wherein the RNN comprises a long-short term memory neural network.

13. The system of claim 8, wherein the RNN comprises gated recurrent units as gating mechanisms for the RNN.

14. The system of claim 8, wherein the system further comprises the attention mechanism-based neural network for the determination of the at least two temporal context vectors.

15. A computer-implemented method, comprising:
encoding, by a computing component operatively coupled to a processor, at least two recurrent neural networks (RNNs) with respective time series data and determining at least two decoded RNNs based on at least two temporal context vectors, to determine temporal dependencies in the at least two time series data;
combining, by a combining component operatively coupled to the processor, the at least two decoded RNNs and determining, by the combining component, an inter-time series dependence context vector and an RNN dependence decoder; and
determining, by an analysis component operatively coupled to the processor, inter-time series dependencies in the at least two time series data and forecast values for one or more time series data based on an RNN encoder and the RNN dependence decoder with an attention mechanism based neural network.

16. The computer-implemented method of claim 15, wherein the computer-implemented method further comprises:
collecting, by a data collection component operatively coupled to the processor, the at least two time series data, wherein the at least two time series data comprises multivariate time series data.

17. The computer-implemented method of claim 15, wherein the encoding and the combining are performed concurrently.

18. The computer-implemented method of claim 15, wherein the RNN comprises a long-short term memory neural network.

19. A computer-implemented method, comprising:
encoding, by a computing component operatively coupled to the processor, at least two recurrent neural networks (RNNs) with respective time series data and determining at least two decoded RNNs based on at least two temporal context vectors, to determine temporal dependencies in at least two time series data;
determining, by a combining component operatively coupled to the processor, an inter-time series dependence context vector and an RNN dependence decoder; and
determining, by an analysis component operatively coupled to the processor, forecast values for one or more time series data based on an RNN encoder and the RNN dependence decoder with an attention mechanism based neural network.

20. The computer-implemented method of claim 19, wherein the encoding and the combining are performed concurrently.

21. The computer-implemented method of claim 19, wherein the RNN comprises a long-short term memory neural network.

22. The computer-implemented method of claim 19, wherein the RNN comprises gated recurrent units as gating mechanisms for the RNN.

23. A computer program product for determining temporal dependencies in time series data using neural networks, comprising a computer readable storage medium having program instructions embodied therewith, the program instructions executable by a processor to cause the processor to:
encode, by the processor, at least two recurrent neural networks (RNNs) with respective time series data and determine at least two decoded RNNs based on at least two temporal context vectors, to determine temporal dependencies in the at least two time series data;
combine, by the processor, the at least two decoded RNNs and determines an inter-time series dependence context vector and an RNN dependence decoder; and
determine, by the processor, an analysis component that determines inter-time series dependencies in the at least two time series data and forecast values for one or more time series data based on an RNN encoder and the RNN dependence decoder with an attention mechanism based neural network.

24. The computer program product of claim 23, wherein an encoding of the at least two RNNs and a combining of the at least two decoded RNNs are performed concurrently.

25. The computer program product of claim 23, wherein the RNN comprises a long-short term memory neural network.
